(19) United States
(12) Patent Application Publication
(10) Pub. No.: US 2011/0177798 A1
(43) Pub. Date: Jul. 21, 2011

(54) MOBILE COMMUNICATION TERMINAL AND METHOD FOR CONTROLLING APPLICATION PROGRAM

(75) Inventor: Hirosi AOKI, Tokyo (JP)

(73) Assignee: KABUSHIKI KAISHA TOSHIBA, Tokyo (JP)

(21) Appl. No.: 12/825,641

(22) Filed: Jun. 29, 2010

(30) Foreign Application Priority Data
Jan. 20, 2010 (JP) P2010-010204

(51) Int. Cl. H04M 3/42; H04B 1/38

(52) U.S. Cl. 455/414.1; 455/566

(57) ABSTRACT

A mobile communication terminal includes a memory section, a registering section, a displaying section, an accepting section and an input section. A plurality of content data can be stored in the memory section. The registering section accepts a user's choice for a content datum while a first application program is being active. The registering section stores the accepted content datum in the memory section. The displaying section displays a list of the content data stored in the memory section upon a particular operation being performed while the mobile communication device is waiting or a second application program is being active. The accepting section accepts a choice for a content datum included in the list of the content data displayed on the display section. The input section inputs the content datum accepted by the accepting section to the second application program.

### CROSS REFERENCE TO RELATED APPLICATIONS

This application is based upon and claims the benefit of priority from the prior Japanese Patent Application No. 2010-10204 filed on Jan. 20, 2010; the entire contents of which are incorporated herein by reference.

### FIELD

The present invention relates to a mobile communication terminal provided with functions for temporarily storing user-specified data in a shared memory area and for inputting the stored data to a user-desired application program.

### BACKGROUND

It is generally known that a mobile communication terminal has a clipboard function in recent years. The clipboard function is a function for temporarily storing user-specified data on a shared memory area of a computer. As the data stored on the clipboard can be accessed by plural different application programs, the clipboard function is used for data transfer not only within a single application program but also among plural application programs.

For instance, a computer system provided with a clipboard function with enhanced usability has been disclosed. The system has a group editor means which operates so that plural computers share results of input and editing operations, and a system clipboard due to an operating system. The system enables a user to carry out a copy and paste operation among different applications and within an editor in a same group by operating the same clipboard.

A mobile communication terminal provided with a clipboard function as described above is inconvenient for a consecutive series of a plurality of file operations such as copy, cut and paste operations, as only one datum can be stored on the clipboard at a time. Further, if data cut or copied from an application program is pasted to another application program, the mobile communication terminal has a problem in that the file on the clipboard cannot be referred to. The problem causes a troublesome tap operation to be required since the application program from which the data is copied or cut is active until the application program to which the data is pasted becomes active.

### BRIEF DESCRIPTION OF THE DRAWINGS

FIG. 1 shows a perspective view of a mobile communication terminal (mobile phone) of the invention.

FIG. 2 is a functional block diagram of the mobile communication terminal (mobile phone) of the invention.

FIG. 3 is a data structure diagram for showing an exemplary clipboard data table.

FIG. 4 is a flowchart for showing a procedure of a content datum recording process performed by the mobile communication terminal (mobile phone) of the invention.

FIG. 5 is a flowchart for showing a procedure of a content datum input process performed by the mobile communication terminal (mobile phone) of the invention.

FIG. 6A shows an exemplary screen on which an application list is displayed in a shared area.

FIG. 6B shows an exemplary screen on which a clipboard is displayed in a shared area.

### DETAILED DESCRIPTION

An advantage of an embodiment is to provide a mobile communication terminal which enables a user to perform simplified file operations such as copy, cut and paste operations among a plurality of application programs by using a clipboard function without depending on a kind of data to be operated.

According to an embodiment, a mobile communication terminal including a memory section, a registering section, a displaying section, an accepting section and an input section is provided. A plurality of content data can be stored in the memory section. The registering section accepts a user's choice for a content datum while a first application program is being active. The registering section stores the accepted content datum in the memory section. The displaying section displays a list of the content data stored in the memory section upon a particular operation being performed while the mobile communication device is waiting or a second application program is being active. The accepting section accepts a choice for a content datum included in the list of the content data displayed on the display section. The input section inputs the content datum accepted by the accepting section to the second application program.

A mobile communication terminal of an embodiment of the present invention will be explained with reference to the drawings. A mobile phone 1 provided with a display (touchscreen) to which a user can input data by touching a screen with a finger, etc. will be explained as an exemplary mobile communication terminal of the present invention,

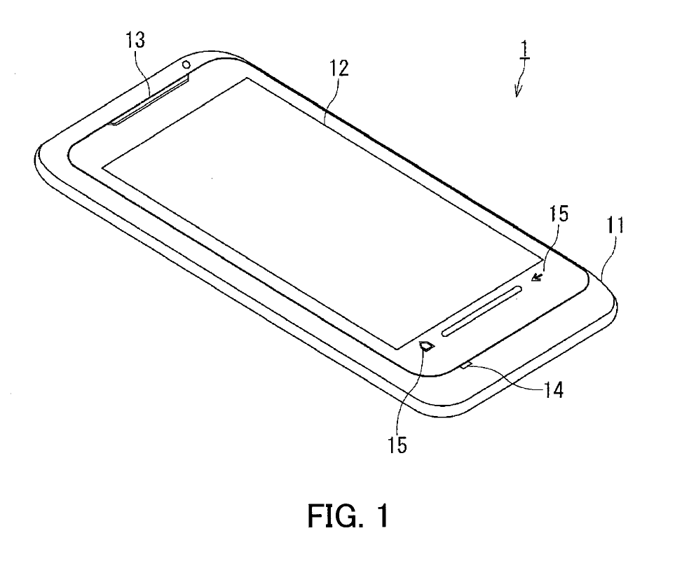

FIG. 1 is a perspective view of the mobile phone 1. The mobile phone 1 has a rectangular plate-like housing 11. The housing 11 is provided on one face with a touchscreen 12 for displaying data and entering data via touch operations, a speaker 13 for producing voice and sound, a microphone 14 for entering voice and sound, and operation keys 15 for entering data.

The touchscreen 12 is a display provided with both a display function for displaying screen data and an input function for allowing a user to input instructions by detecting a point at which the user touches the screen by using a finger or an exclusive stylus. The touch screen 12 is formed, e.g., by a plurality of elements arranged on the display for sensing contact on the surface, and a transparent screen further layered above the elements. The touchscreen 12 can sense contact by using a pressure-sensitive method for sensing a change of pressure, an electrostatic method for sensing an electric signal caused by static electricity, or another method. The operation keys 15 can be operation keys which sense contact by using a pressure-sensitive or electrostatic method, or operation keys which the user physically presses so as to input data.

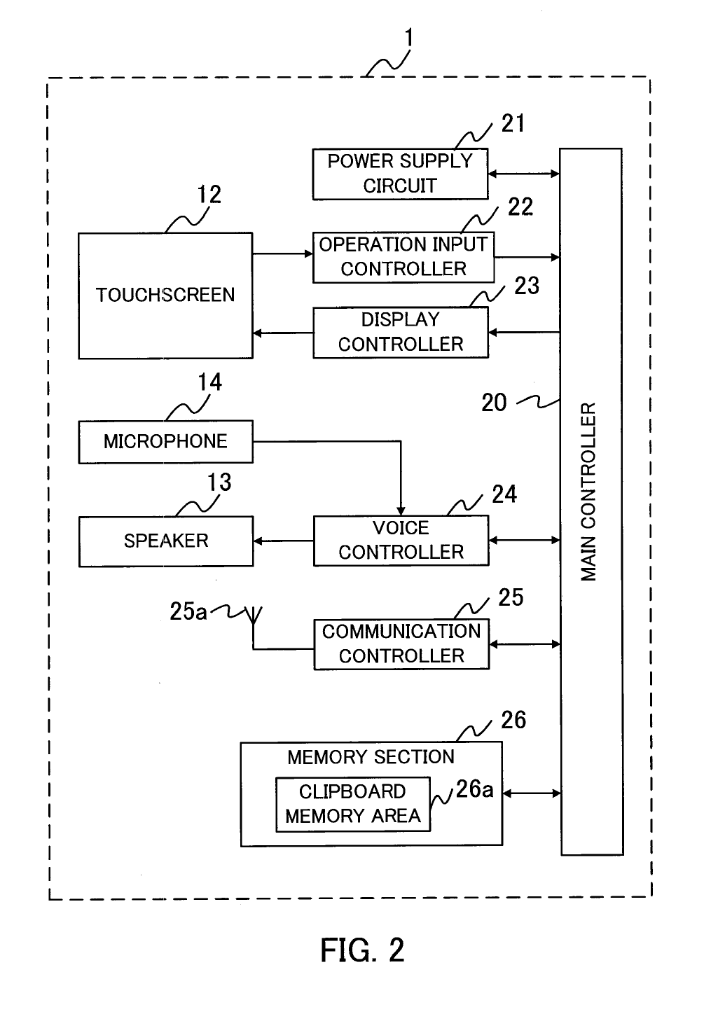

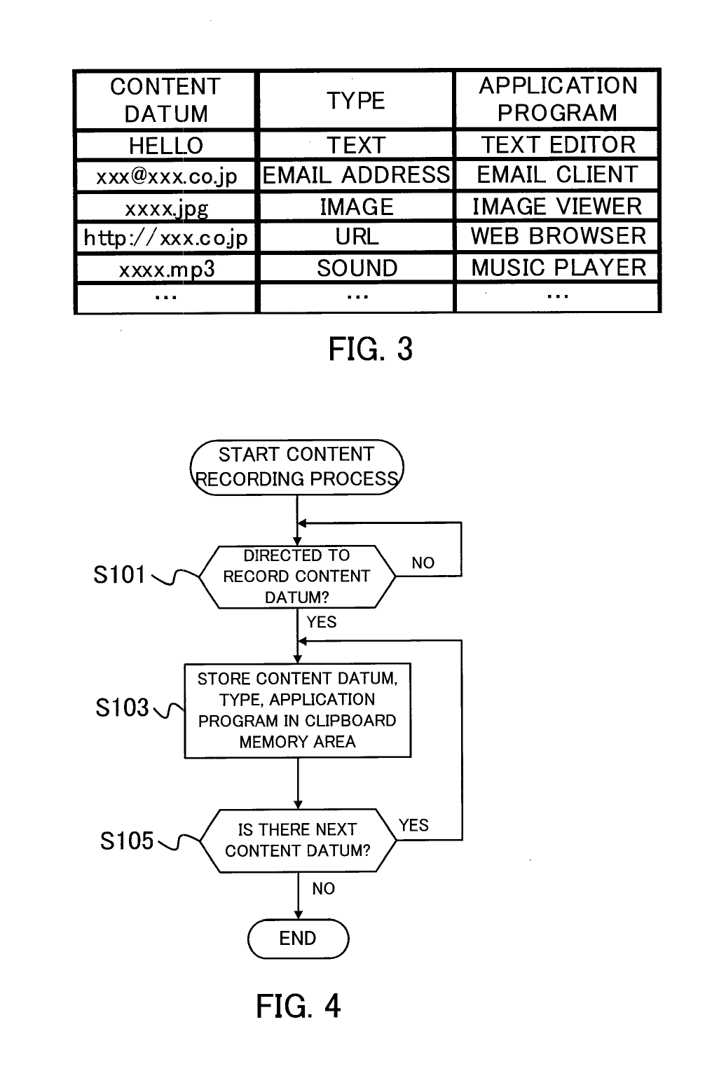

FIG. 2 is a functional block diagram of the mobile phone 1. As shown in FIG. 3, the mobile phone 1 has a main controller 20, a power supply circuit 21, an operation input controller 22, a display controller 23, a voice controller 24, a communication controller 25 and a memory section 26 which are connected and enabled to communicate with one another via a bus.

The main controller 20 is provided with a CPU (Central Processing Unit), controls the whole mobile phone 1, and carries out a content recording process, a content inputting process and other various arithmetic and control processes described later. The power supply circuit 21 is provided with a power source (a battery, etc.). The power supply circuit 21 changes a state as to whether the mobile phone 1 is powered on or off on the basis of an input operation via the relevant operation key 15. While the mobile phone 1 is being powered on, the power supply circuit 21 supplies each of the portions with power from the power source so as to make the mobile phone 1 ready to work.

The operation input controller 22 is provided with an input interface to the touchscreen 12. Upon sensing contact on the touchscreen 12, the operation input controller 22 produces a signal indicating where the contact is sensed, and transmits the signal to the main controller 20. Upon receiving the signal, the main controller 20 carries out various processes on the basis of the signal. The display controller 23 is provided with a display interface to the touchscreen 12. The display controller 23 produces data to be displayed and displays the data on the touchscreen 12 as controlled by the main controller 20.

The voice controller 24 produces an analog voice signal from voice collected by the microphone 14, and converts the analog voice signal to a digital voice signal. Upon obtaining a digital voice signal, the voice controller 24 converts the digital voice signal into an analog voice signal as controlled by the main controller 20, and produces voice from the speaker 13.

The communication controller 25 is provided with an antenna 25a, and carries out a spectrum-despreading process on a signal received from a base station via the antenna 25a so as to restore data as controlled by the main controller 20. The data is, as directed by the main controller 20, transferred to the voice controller 24 so as to be produced from the speaker 13, transferred to the display controller 23 so as to be displayed on the touchscreen 12, or stored in the memory section 26. Further, upon obtaining voice data collected by the microphone 14, data entered via the touchscreen 12 or data stored in the memory section 26 as controlled by the main controller 20, the communication controller 25 carries out a spectrum-spreading process on the data so as to transmit the spectrum-spread signal to the base station via the antenna 25a.

The memory section 26 is constituted by a ROM (Read Only Memory), a hard disk or a non-volatile memory in which a control program or data required for processes carried out by the main controller 20 is stored, a RAM (Random Access Memory) in which data used by the main controller 20 carrying out a process is temporarily stored, etc. Further, assume that programs to be run by the main controller 20 carrying out the content recording process and the content inputting process described later are stored, e.g., in the ROM.

Further, the memory section 26 includes a clipboard memory area 26a in which data to be used for file operations such as copy, cut and paste operations is stored. In the clipboard memory area 26a, a clipboard data table 30 in which content data chosen by a user in advance are enumerated is stored. The clipboard data table 30 is used for file operations within a same application program or between different application programs.

FIG. 3 is a data structure diagram for showing an exemplary clipboard data table 30. The clipboard data table 30 enumerates data to be used for the file operations. As shown in FIG. 3, each one (content datum) of a plurality of content data 31 is enumerated while being associated with a type datum 32 indicating a type of the content and an application datum 33 indicating an application program for using the content.

The content datum 31 can be a datum of the content itself or a datum indicating where the content is stored. The type of the content is, e.g., text, image or voice. As the application datum 33, e.g., a text editor, an email client and a Web browser are associated with content data of text, an email address and a URL, respectively.

If a user chooses a content datum while any application program is being active, the mobile phone 1 records the content datum in such a way as to add the content datum to the clipboard data list 30. The mobile phone 1 carries out the content recording process in accordance with a procedure explained below with reference to FIG. 4.

While browsing Websites by using a Web browser or listening to music by using a music player, e.g., the user chooses a content datum of text or music by means of an input operation via the touchscreen 12 so as to direct the mobile phone 1 to record the content datum as the clipboard data table 30. Thus, the main controller 20 identifies whether the mobile phone 1 is directed to record a content datum (S101). If the mobile phone 1 is directed to record no content datum (No of S101), the main controller 20 remains to wait.

If the mobile phone 1 is directed to record a content datum (Yes of S101), the main controller 20 stores the content datum directed to be recorded at the step S101 on the clipboard memory area 26a while being associated with a type of the content datum and an application program for using the content datum (S103). On this occasion, the type of the content datum is preferably identified from what is included in the content datum, and the application program is preferably identified from the type of the content datum.

The main controller 20 identifies whether there is a next content datum (S105). On this occasion, if the user directs the mobile phone 1 to record a plurality of content data or a series of content data at the step S101, the main controller 20 identifies a next content datum as being present. If there is a next content datum (Yes of S105), the main controller 20 returns to the step S103 and similarly stores the next content datum in the clipboard memory area 26a in association with the type of the content datum and the application program for using the content datum.

As described above, the mobile phone 1 stores one content datum or a plurality of content data in the clipboard memory area 26a in association with the respective types and application programs. Then, the clipboard data table 30 stored in the clipboard memory area 26a is displayed in a shared area 42 which can be displayed on the touchscreen 12 as operated by a user in any state in which the mobile phone 1 is waiting or any application program is being active. Incidentally, the content datum displayed in the shared area 42 is used for a file operation as directed by the user.

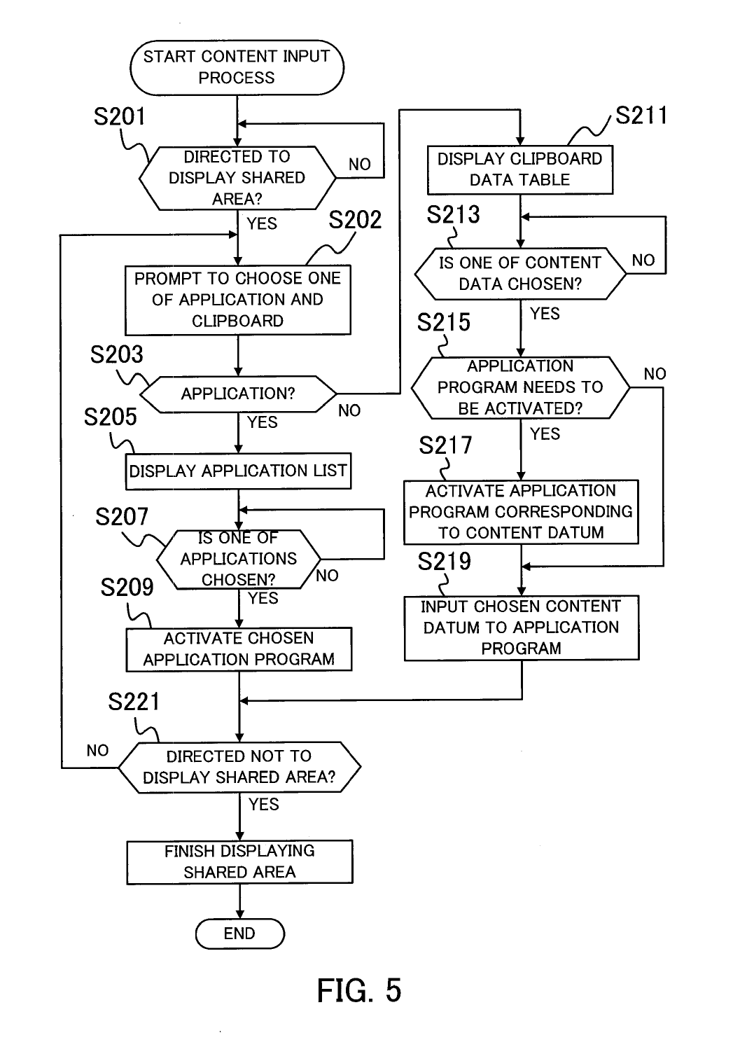

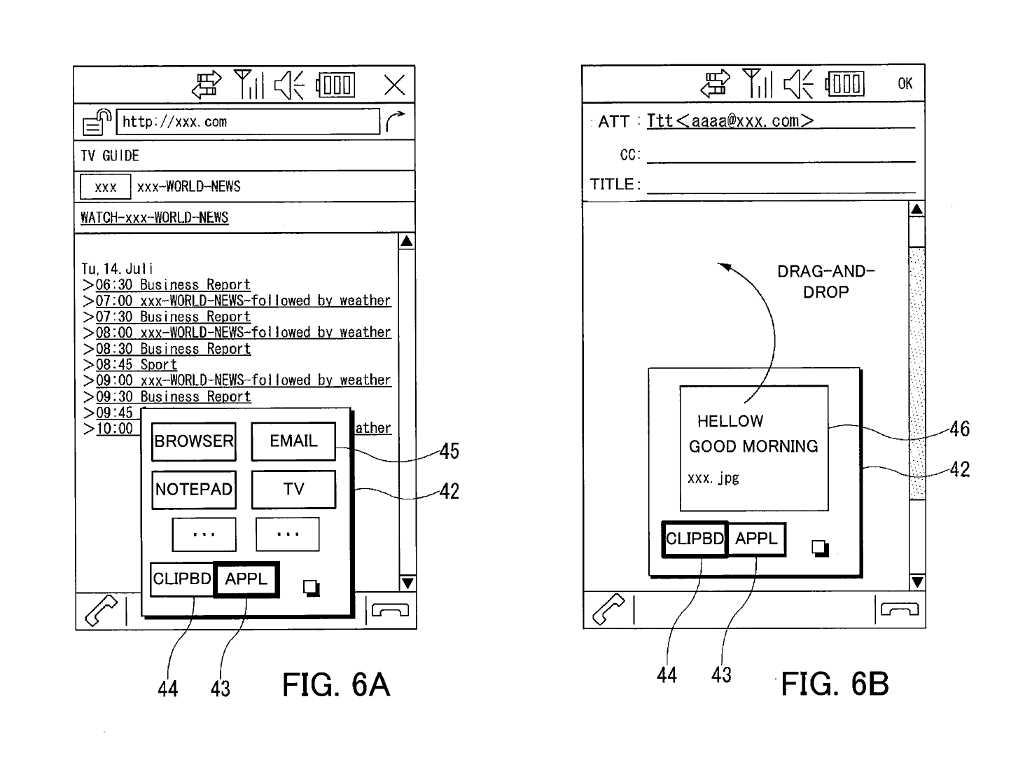

The mobile phone 1 can input a content datum stored in the clipboard data table 30 to an application program desired by the user by displaying the shared area 42 as operated by the user while the mobile phone 1 is waiting or any application program is being active. The mobile phone 1 carries out such a content input process in accordance with a procedure as explained below with reference to a flowchart shown in FIG. 5 and screen diagrams shown in FIGS. 6A and 6B.

The clipboard data table 30 is displayed in the shared area 42, as described above, and is input to the user-desired application program as operated by the user. The main controller 20 identifies whether the mobile phone 1 is directed to display the shared area 42 (S201). On this occasion, the main controller 20 identifies the mobile phone 1 as being directed to display the shared area 42, e.g., if the user performs a certain operation via the touchscreen 12. If the mobile phone 1 is not directed to display the shared area 42 (No of S201), the main controller 20 remains to wait.

If the mobile phone 1 is directed to display the shared area 42 (Yes of S201), the main controller 20 displays the shared area 42 on the touchscreen 12, and prompts the user to choose one of a list of application programs and the clipboard data table 30 (S202). That is, the mobile phone 1 can alternately display the clipboard data table 30 and the list of application programs in the shared area 42, so that the user can not only perform data operation but also activate the application programs from the shared area 42 by using the clipboard data table 30.

FIGS. 6A and 6B are screen diagrams for showing exemplary screens displayed on the touchscreen 12 when the mobile phone 1 is used for the content input process. FIG. 6A shows a screen on which a list of application programs is shown in the shared area 42. FIG. 6B shows a screen on which the clipboard data table 30 is shown in the shared area 42. The shared area 42 includes an application choice button 43 for displaying the list of application programs and a clipboard choice button 44 for displaying the clipboard data table 30, e.g., as shown in FIGS. 6A and 6B. The user is prompted by the shared area 42 to choose one of the application choice button 43 and the clipboard choice button 44.

The main controller 20 identifies whether the list of application programs is chosen to be displayed (S203). On this occasion, the main controller 20 identifies the mobile phone 1 as being directed to display the list of application programs on the basis of a fact that the application choice button 43 is chosen. If the mobile phone 1 is directed to display the list of application programs (Yes of S203), the main controller 20 displays the list of application programs in the shared area 42 (S205).

If the list of application programs is displayed, as shown in FIG. 6A, activating buttons 45 for activating application programs for a browser function, an email function, etc. are displayed in the shared area 42. The user chooses one of the activating buttons 45.

The main controller 20 identifies which one of the application programs is chosen (S207). On this occasion, the main controller 20 identifies one of the application programs as being chosen on the basis of a fact that one of the activating buttons 45 is chosen. If one of the application programs is chosen (Yes of S207), the main controller 20 activates the chosen application program (S209).

Meanwhile, unless the mobile phone 1 is directed to display the list of application programs (No of S203), i.e., if the mobile phone 1 is directed to display the clipboard data table 30, the main controller 20 displays the clipboard data table 30 in the shared area 42 (S211). If the clipboard data table 30 is displayed, as shown in FIG. 6B, a content data window 46 in which a list of the respective content data included in the clipboard data table 30 is displayed is displayed in the shared area 42. The user chooses one of the content data in the content data window 46.

The main controller 20 identifies whether one of the content data is chosen by the user (S213). If one of the content data is chosen (Yes of S213), the main controller 20 identifies whether an application program corresponding to the chosen content datum needs to be activated (S215). If, e.g., the user moves the content datum to an application program being active then by means of a drag-and-drop operation, the main controller 20 identifies the application program as having no need to be activated afresh.

If an application program needs to be activated (Yes of S215), the main controller 20 activates the application program (S217). If, e.g., the user ordinarily chooses a content datum, the main controller 20 activates an application program associated with the content datum on the clipboard data table 30. If, e.g., an email address is chosen as a content datum included in the clipboard data table 30, an email client application program is activated.

Incidentally, it is acceptable to let the user choose whether to activate the corresponding application program at the step S215. Further, it is acceptable to make the main controller 20 not activate the application program at the step S215, and activate the application program if one of the starting buttons 45 is chosen after the user chooses the application choice button 43 from the shared area 42.

The main controller 20 inputs the chosen content datum to the application program (S219). If the user moves the content datum to an application program being active then by means of a drag-and-drop operation, e.g., the main controller 20 inputs the content datum stored in the clipboard data table 30 to the application program being active. Further, if the user ordinarily chooses a content datum, e.g., the main controller 20 inputs the chosen content datum to an application program at the time of activating the application program.

After finishing the process of the step S209 or S219, the main controller 20 identifies whether the mobile phone 1 is directed not to display the shared area 42 (S221). On this occasion, the main controller 20 can identify the mobile phone 1 as being directed not to display the shared area 42 if the user performs a certain operation, or upon finishing the process of the step S209 or S219 as well.

Unless the mobile phone 1 is directed not to display the shared area 42 (No of S221), return to the step S202. Further, if the mobile phone 1 is directed not to display the shared area 42 (Yes of S221), the main controller 20 finishes displaying the shared area 42 (S223) and ends the content datum input process.

As described above, the mobile phone 1 displays the shared area 42 as directed by the user so that the user can choose a content datum included in the clipboard data table 30 displayed in the shared area 42. The mobile phone 1 activates an application program as necessary, and inputs the chosen content datum to the application program as well. Thus, if the user wants to use data recorded on the clipboard data table 30, the user can easily operate the data recorded on the clipboard data table 30.

Assume, e.g., that an email address is recorded on the clipboard data table 30 as a content datum and that an application program for implementing an email writing function is associated with the content datum. In such a case, even if an email writing function of the mobile phone 1 is being inactive, the mobile phone 1 can display a screen for email writing in which the email address is set to the destination address by means of the user's one operation such that the email address is chosen from the shared area 42.

Further, as a content datum and an application program are associated with each other on the clipboard data table 30, the mobile phone 1 can activate an optimum application program that matches an operation of a content datum, so that the user can omit a troublesome operation for activating the application program.

Further, both the clipboard data table 30 and the application program list can be operated in the shared area 42. Thus, while an application program of the mobile phone 1 is being run, another application program can be activated from the shared area 42.

Following functions can be registered for a launcher.

The mobile communication terminal (mobile phone 1) of the invention can enable a user to perform simplified file operations such as copy, cut and paste operations by using a clipboard function without depending on a kind of data to be operated.

The invention is not limited to the mobile phone 1 explained above, and can be applied to any type of mobile communication terminals such as a PHS (Personal Handyphone System), a PDA (Personal Digital Assistant), an MID (Mobile Internet Device), a portable music player, a portable video camera and a portable game machine.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A mobile communication terminal comprising:
a memory section in which a plurality of content data can be stored;
a registering section which accepts a user's choice for a content datum while a first application program is being active, the registering section being configured to store the accepted content datum in the memory section;
a displaying section which displays a list of the content data stored in the memory section upon a particular operation being performed while the mobile communication device is waiting or a second application program is being active;
an accepting section which accepts a choice for a content datum included in the list of the content data displayed on the display section; and
an input section which inputs the content datum accepted by the accepting section to the second application program.

2. The mobile communication terminal according to claim 1, wherein the input section inputs the content datum accepted by the accepting section to a third application program which is different from the second application program.

3. The mobile communication terminal according to claim 1, wherein
each of the content data is stored in the memory section in association with an application program, and
the input section inputs the content datum accepted by the accepting section to the application program associated with the content datum.

4. The mobile communication terminal according to claim 1, wherein
each of the content data is stored in the memory section in association with an application program, and
the input section activates the application program associated with the content datum accepted by the accepting section, the input section being configured to input the content datum to the activated application program.

5. The mobile communication terminal according to claim 1, wherein
the displaying section alternately displays the list of the content data and a list of a plurality of application programs provided to the mobile communication terminal,
the accepting section accepts a choice for one of the application programs upon the displaying section displaying the list of the application programs, and
the mobile communication terminal further comprises an activating section which activates the application program accepted by the accepting section.

6. The mobile communication terminal according to claim 1, wherein
the input section inputs the content datum accepted by the accepting section to a third application program which is different from the second application program;
the displaying section alternately displays the list of the content data and a list of a plurality of application programs provided to the mobile communication terminal,
the accepting section accepts a choice for one of the application programs upon the displaying section displaying the list of the application programs, and
the mobile communication terminal further comprises an activating section which activates the application program accepted by the accepting section.

7. A method for controlling application programs by means of a mobile communication terminal having a memory section, comprising:
storing a plurality of content data in the memory section;
accepting a user's choice for a content datum while a first application program is being active;
storing the chosen content datum in the memory section;
displaying a list of the content data stored in the memory section upon a particular operation being performed while the mobile communication device is waiting or a second application program is being active;
accepting a choice for a content datum included in the list of the content data; and
inputting the accepted content datum to the second application program.

8. The method for controlling application programs according to claim 7, further comprising
inputting the content datum accepted by the accepting section to a third application program which is different from the second application program.

9. The method for controlling application programs according to claim 7, wherein
each of the content data is stored in the memory section in association with an application program, and
the accepted content datum is input to the application program associated with the content datum.

10. The method for controlling application programs according to claim 7, wherein
each of the content data is stored in the memory section in association with an application program, and
the accepted content datum is input to the application program associated with the content datum after the application program is activated.

11. The method for controlling application programs according to claim 7, further comprising
displaying a list of a plurality of application programs provided to the mobile communication terminal in an alternate manner with the list of the content data,
accepting a choice for one of the application programs upon the list of the application programs being displayed, and
activating the accepted application program.

12. The method for controlling application programs according to claim 7, further comprising
inputting the content datum accepted by the accepting section to a third application program which is different from the second application program,
displaying a list of a plurality of application programs provided to the mobile communication terminal in an alternate manner with the list of the content data,
accepting a choice for one of the application programs upon the list of the application programs being displayed, and
activating the accepted application program.
